(19) United States
(12) Patent Application Publication
(10) Pub. No.: US 2013/0232446 A1
(43) Pub. Date: Sep. 5, 2013

(54) ELECTRONIC DEVICE AND METHOD FOR UNLOCKING ELECTRONIC DEVICE

(71) Applicant: Chih-Yung Lin, Kuei Shan Hsiang (TW)

(72) Inventor: Chih-Yung Lin, Kuei Shan Hsiang (TW)

(73) Assignee: QUANTA COMPUTER INC., Kuei Shan Hsiang (TW)

(21) Appl. No.: 13/564,380

(22) Filed: Aug. 1, 2012

(30) Foreign Application Priority Data
Mar. 1, 2012 (TW) 101106653

(51) Int. Cl. G06F 3/041; G06F 3/048

(52) U.S. Cl. 715/810

(57) ABSTRACT

The present invention provides an electronic device including a touch screen, an image processing unit, a determination unit, and a switching unit. The touch screen receives a predetermined gesture and displays a plurality of screen layers including a lock layer and a desktop. The image processing unit inserts the lock layer above the desktop in a locked mode, wherein the lock layer comprises a lock icon disposed at a predetermined position. The determination unit determines whether the predetermined gesture has been executed at the predetermined position on the lock layer when the touch screen has been triggered by the predetermined gesture in the lock mode. The switching unit forces the electronic device to enter a normal operating mode from the lock mode and execute an application corresponding to the lock icon at the predetermined position when the predetermined gesture has been executed at the predetermined position.

### CROSS REFERENCE TO RELATED APPLICATIONS

This Application claims priority of Taiwan Patent Application No. 101106653, filed on Mar. 1, 2012, the entirety of which is incorporated by reference herein.

### BACKGROUND OF THE INVENTION

1. Field of the Invention

The present invention relates to a method for unlocking an electronic device, and in particular relates to a method for unlocking an electronic device by tapping an icon on the desktop of the electronic device during a locked state.

2. Description of the Related Art

Presently, mobile devices are highly developed and multi-functional. For example, handheld devices, such as mobile phones or tablets, are capable of telecommunications, receiving/transmitting e-mails, maintaining social networks, managing contacts, and playing media, etc. Hence, users can implement various applications on their mobile devices, such as a simple phone call, social network, or commercial transaction. Therefore, mobile devices have becomes one of the necessities of people's lives, and the recording of personal information stored in the mobile device have become increasingly diverse and important.

Most of the current handheld devices include touch screens and touch units. Users may input information and commands by it. When a user has not operated the handheld device for a predetermined amount of time, the device will automatically enter a locked state. Hence, the user has to unlock the device to operate the device in a normal operation mode.

Generally, the handheld device can be unlocked by entering a predetermined code or sliding the screen according to the instruction on the device, and a specific application must be enabled by selecting the icon of the specific application after unlocking the handheld device when the user wants to implement the specific application. However, the operations and codes of unlocking are complicated and needs to be memorized, which may cause inconvenience for users in some conditions.

### BRIEF SUMMARY OF THE INVENTION

A detailed description is given in the following embodiments with reference to the accompanying drawings.

The present invention provides an electronic device capable of operating in a normal operating mode or a locked mode. The electronic device includes a touch screen, an image processing unit, a determination unit, and a switching unit. The touch screen is configured to receive a predetermined gesture and display a plurality of screen layers, wherein the screen layers comprise a lock layer corresponding to the locked mode and a desktop corresponding to the normal operating mode. The image processing unit is configured to insert the lock layer above the desktop when the electronic device is in the locked mode, wherein the lock layer includes a first non-transparent area having a lock icon, and the lock icon is disposed at a first predetermined position on the lock layer. The determination unit is configured to determine whether the predetermined gesture has been executed at the first predetermined position on the lock layer when the electronic device is in the lock mode and the touch screen has been triggered by the predetermined gesture. The switching unit is configured to force the electronic device to enter the normal operating mode from the lock mode and execute a first application corresponding to the lock icon at the first predetermined position when the predetermined gesture has been executed at the first predetermined position on the lock layer.

The present invention further provides a method for unlocking an electronic device, wherein the electronic device is capable of operating in a normal operating mode or a locked mode and includes a touch screen. The method includes inserting a lock layer above a desktop corresponding to the normal operating mode when the electronic device is in the locked mode, wherein the lock layer includes a first non-transparent area, and the first non-transparent area includes a lock icon disposed at a first predetermined position; determining whether the touch screen has been triggered by a predetermined gesture when the electronic device is in the locked mode; determining whether the predetermined gesture has been executed on the lock layer when the touch screen has been triggered by the predetermined gesture; determining whether the predetermined gesture has been executed at the first predetermined position when the predetermined gesture has been executed on the lock layer; and forcing the electronic device to enter the normal operating mode from the locked mode and execute a first application corresponding to the lock icon at the first predetermined position when the predetermined gesture has been executed at the first predetermined position.

### BRIEF DESCRIPTION OF THE DRAWINGS

The present invention can be more fully understood by reading the subsequent detailed description and examples with references made to the accompanying drawings, wherein:

FIG. 1 is a schematic diagram illustrating an embodiment of a lock layer and a desktop of the present invention;

FIG. 2 is a schematic diagram illustrating another embodiment of a lock layer of the present invention;

FIG. 3 is a schematic diagram illustrating an embodiment of a desktop, a lock layer and an event layer of the present invention;

FIG. 4 is a schematic diagram illustrating another embodiment of a desktop, a lock layer and an event layer of the present invention;

FIG. 5 is a schematic diagram illustrating another embodiment of an event layer of the present invention;

FIG. 6 is a schematic diagram illustrating an embodiment of an electronic device of the present invention; and

FIGS. 7A-7B illustrate a flowchart of a method for unlocking the electronic device according to an embodiment of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

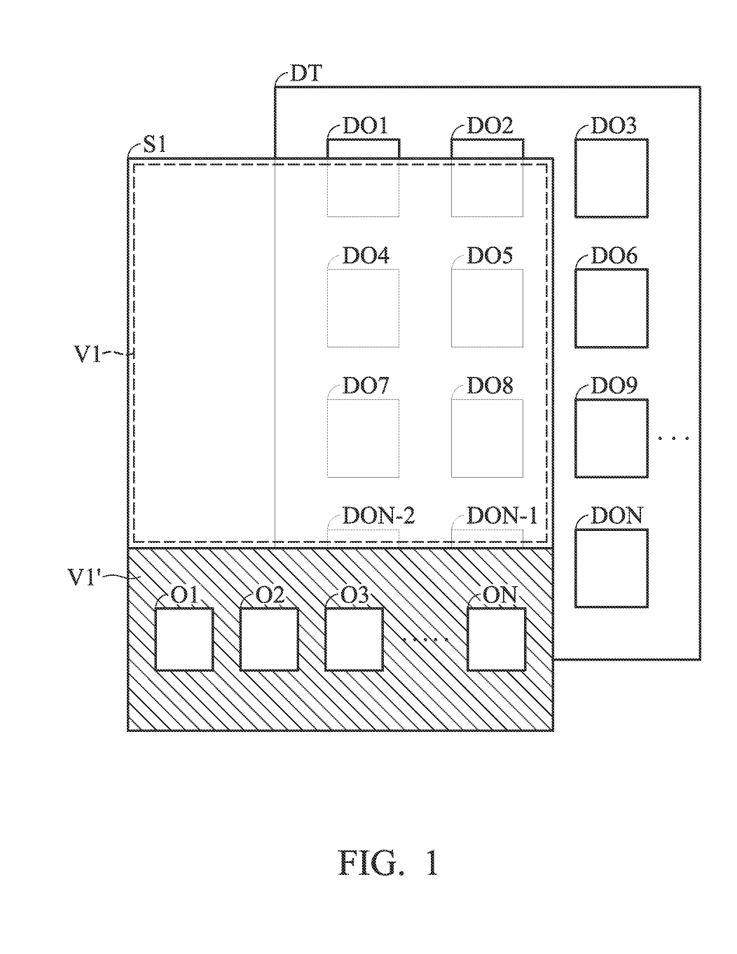

FIG. 1 is a schematic diagram illustrating an embodiment of a lock layer and a desktop of the present invention. The lock layer S1 includes a first transparent area V1 and a first non-transparent area V1′, wherein the first non-transparent area V1′ includes a plurality of lock icons O1-ON, and the lock icons O1-ON are disposed at different predetermined positions (i.e. first predetermined positions) and correspond to different applications, respectively. For example, the lock icon O1 can be an unlock button, the lock icon O2 can be a voice call application, etc., but the invention is not limited thereto. The desktop DT includes a plurality of the desktop icons DO1-DON, and the desktop icons DO1-DON are disposed at different predetermined positions (i.e. second predetermined positions) and corresponding to different applications, respectively. For example, the desktop icon DO1 can be a music application, the desktop icon DO2 can be a photogram application, etc., but the invention is not limited thereto. Additionally, the first transparent area V1 is configured to display at least one of the desktop icons on the desktop DT when the lock layer S1 is inserted above the desktop DT. Namely, the first transparent area V1 displays at least one of the desktop icons on the desktop DT when the desktop DT is covered with the lock layer S1. For example, users can see the desktop icons DO1-DO9 on the desktop DT through the first transparent area V1 of the lock layer S1 when the lock layer S1 is inserted above the desktop DT. In another embodiment, the lock layer S1 only has one lock icon, and the desktop DT only has one desktop icon, however, they are not limited thereto.

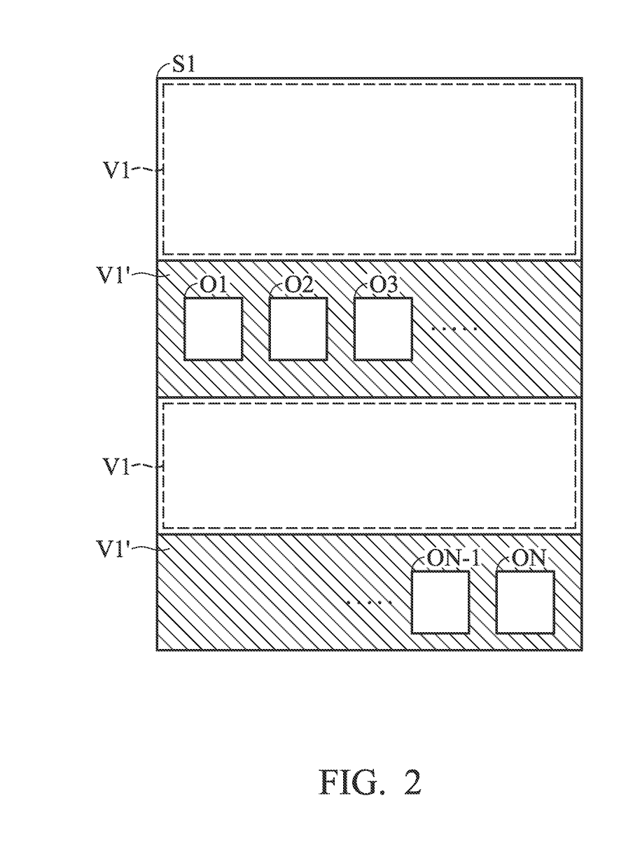

FIG. 2 is a schematic diagram illustrating another embodiment of a lock layer of the present invention. The lock layer S1 of FIG. 2 is similar to the lock layer S1 of FIG. 1 except that the lock layer S1 of FIG. 2 includes more than one first transparent areas V1 and first non-transparent areas V1′. For the details of the lock layer S1 in FIG. 2, reference can be made to FIG. 1, and it is not discussed in further detail herein.

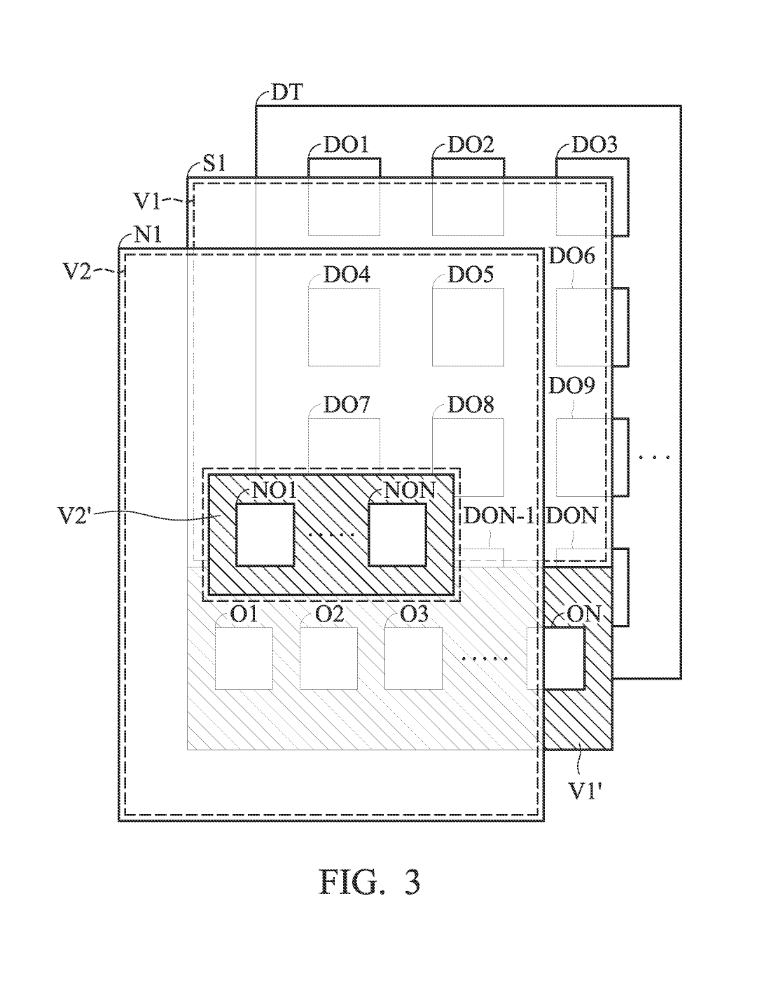

FIG. 3 is a schematic diagram illustrating an embodiment of a desktop, a lock layer and an event layer of the present invention. FIG. 3 is similar to FIG. 1 except for the event layer N1. The event layer N1 includes a second transparent area V2 and a second non-transparent area V2′, wherein the second non-transparent area V2′ includes a plurality of event icons NO1-NON. The event icons NO1-NON are disposed at different predetermined positions (i.e. the third predetermined positions) and corresponding to different applications, respectively. For example, the event icon NO1 can correspond to answering a phone call when the new event is an incoming call, but it is not limited thereto. Additionally, the second transparent area V2 is configured to display at least one lock icon on the lock layer S1 and/or at least one desktop icon on the desktop DT when the event layer N1 is inserted above the lock layer S1 and the desktop DT. For example, users can see the lock icons O1-ON on the lock layer S1 through the second transparent area V2 when the event layer N1 is inserted above the lock layer S1 and the desktop DT. Furthermore, users can see the desktop icons DO1-DO3 and DO7-DO9 on the desktop DT through the first transparent area V1 and the second transparent area V2 when the event layer N1 is inserted above the lock layer S1 and the desktop DT. In another embodiment, the event layer N1 has only one event icon, and it is not limited thereto.

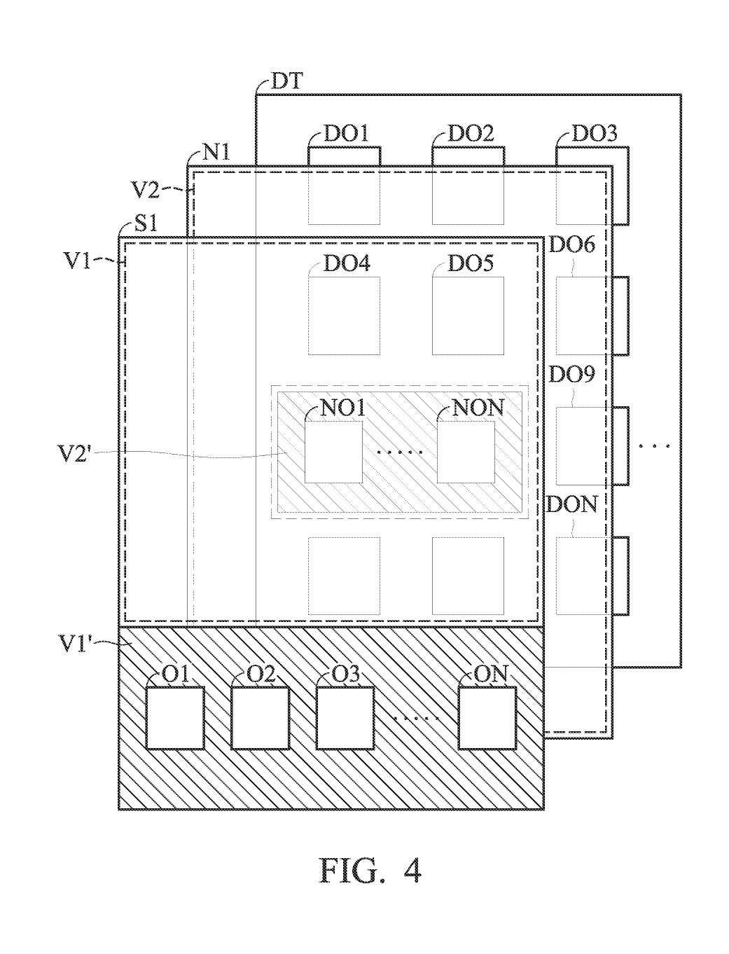

It should be noted that the event layer N1 can be inserted between the lock layer S1 and the desktop DT, as shown in FIG. 4. FIG. 4 is similar to FIG. 3 except for the position of the event layer N1 which is inserted between the lock layer S1 and the desktop DT. For example, users can see the event icons NO1-NON on the event layer N1 through the first transparent area V1 when the event layer N1 is inserted between the lock layer S1 and the desktop DT. Additionally, users can see the desktop icons DO1-DO3 and DO7-DO9 on the desktop DT through the first transparent area V1 and the second transparent area V2 when the event layer N1 is inserted between the lock layer S1 and the desktop DT. In another embodiment, the event layer N1 only has one event icon, and it is not limited thereto.

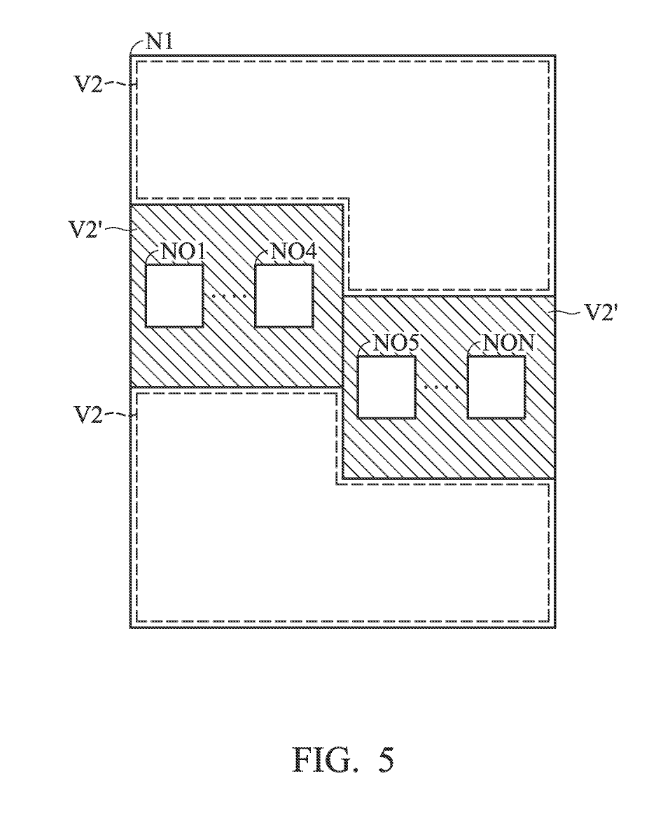

FIG. 5 is a schematic diagram illustrating another embodiment of an event layer of the present invention. The event layer N1 of FIG. 5 is similar to the event layers N1 of FIGS. 3-4, except that the event layer N1 of FIG. 5 includes more than one second transparent areas V2 and second non-transparent areas V2′. For the details of the event layer N1, reference can be made to FIGS. 3-4, and it is not discussed in further detail herein.

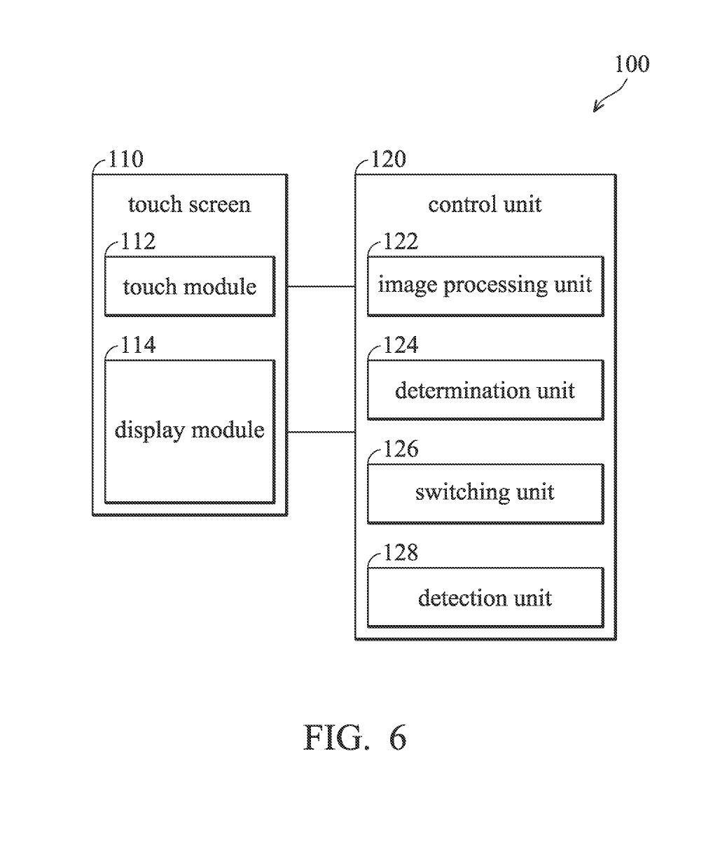

FIG. 6 is a schematic diagram illustrating an embodiment of an electronic device of the present invention, wherein the electronic device 100 is capable of operating in a normal operating mode or a locked mode. The electronic device 100 includes a touch screen 110 and a control unit 120. It should be noted that the electronic device 100 can be a mobile phone, a tablet, etc., and it is not limited thereto.

The touch screen 110 includes a touch module 112 and a display module 114. The touch module 112 is configured to receive a predetermined gesture. The display module 114 is configured to display a plurality of screen layers, wherein the displayed screen layers include at least one lock layer S1 corresponding to the locked mode and a desktop DT corresponding to the normal operating mode, as FIG. 1 shows. It should be noted that the screen layers not only include the lock layer S1 corresponding to the locked mode and the desktop DT corresponding to the normal operating mode, but also include an event layer N1 corresponding to a new event, as FIGS. 3-4 shows. Additionally, the predetermined gesture of the present invention can be ticking or circling action, but it is not limited thereto.

The control unit 120 includes an image processing unit 122, a determination unit 124, a switching unit 126, and a detection unit 128. The image processing unit 122 is configured to insert the lock layer S1 above the desktop DT when the electronic device 100 is in the locked mode, as shown in FIG. 1. In another embodiment, the image processing unit 122 is further configured to insert at least one event layer N1 above the lock layer S1 or between the lock layer S1 and the desktop DT as shown in FIGS. 3-4, when a new event has occurred in the locked mode, wherein the event layer N1 includes at least one second transparent area V2.

The determination unit 124 is configured to determine whether the predetermined gesture has been executed on the lock layer S1 or the desktop DT when the touch screen 110 has been triggered by the predetermined gesture in the locked mode. Namely, the determination unit 124 determines whether the predetermined gesture has been executed on the lock layer S1 or the desktop DT after the touch screen 110 has detected a predetermined gesture in the locked mode. When the predetermined gesture has been executed on the lock layer S1, the determination unit 124 is further configured to determine whether the predetermined gesture has been executed at a predetermined position corresponding to one of the lock icons O1-ON. When the predetermined gesture has been executed on the desktop DT, the determination unit 124 is further configured to determine whether the predetermined gesture has been executed at a predetermined position corresponding to one of the desktop icons DO1-DON.

Additionally, the determination unit 124 determines whether the predetermined gesture has been executed on the desktop DT or the lock layer S1 according to the first transparent area V1 and the position of the predetermined gesture on the touch screen 110. For example, the determination unit 124 determines whether the touch screen 110 has been triggered by the predetermined gesture according to the signal produced by the touch screen 110. Furthermore, as shown in FIG. 1, when the touch screen 110 has been triggered by the predetermined gesture, the determination unit 124 determines whether the predetermined gesture has been executed on the desktop DT or the lock layer S1 according to whether the predetermined gesture has been executed on the first transparent area V1. The determination unit 124 determines that the predetermined gesture has been executed on the desktop DT when the predetermined gesture has been executed on the first transparent area V1 instead of the first non-transparent area V1′. The determination unit 124 determines that the predetermined gesture has been executed on the lock layer S1 when the predetermined gesture has not been executed on the first transparent area V1. Namely, the determination unit 124 determines that the predetermined gesture has been executed on the lock layer S1 when the predetermined gesture has been executed on the first non-transparent area V1′. The determination unit 124 determines whether the predetermined gesture has been executed at the predetermined position corresponding to one of the lock icons O1-ON, when the determination unit 124 determines that the predetermined gesture has been executed on the lock layer S1. In another embodiment, the determination unit 124 is further configured to determine whether the predetermined gesture has been executed on the desktop DT, the lock layer S1, or the event layer N1 according to the first transparent area V1, the first non-transparent area V1′, the second transparent area V2, the second non-transparent area V2′, and the position of the predetermined gesture on the touch screen 110. For example, as shown in FIG. 3, the determination unit 124 determines whether the touch screen 110 has been triggered by the predetermined gesture according to the signal produced by the touch screen 110. The determination unit 124 determines that the predetermined gesture has been executed on the event layer N1, when the predetermined gesture has been executed on the second non-transparent area V2′ instead of the second transparent area V2. The determination unit 124 determines that the predetermined gesture has been executed on the lock layer S1, when the predetermined gesture has been executed on the second transparent area V2 and the first non-transparent area V1′. The determination unit 124 determines that the predetermined gesture has been executed on the desktop DT, when the predetermined gesture has been executed on the first transparent area V1 and the second transparent area V2. Similarly, for the details of FIG. 4, reference can be made to the above description. It should be noted that, in the FIG. 4, the determination unit 124 determines that the predetermined gesture has been executed on the lock layer S1, when the predetermined gesture has been executed on the first non-transparent area V1′ instead of the first transparent area V1. The determination unit 124 determines the predetermined gesture has been executed on the event layer N1, when the predetermined gesture has been executed on the first transparent area V1 and the second non-transparent area V2′. The determination unit 124 determines that the predetermined gesture has been executed on the desktop DT, when the predetermined gesture has been executed on the first transparent area V1 and the second transparent area V2. Additionally, in some of the embodiments, the first transparent area V1 does not overlap with the first non-transparent area V1′, and the second transparent area V2 does not overlap with the second non-transparent area V2′.

When the predetermined gesture has been executed at the predetermined position corresponding to one of the lock icons O1-ON on the lock layer S1, the switching unit 126 forces the electronic device 100 to enter the normal operating mode from the locked mode and execute the application corresponding to the lock icon at the executed predetermined position. Additionally, when the predetermined gesture has been executed at the predetermined position corresponding to one of the desktop icons DO1-DON of the desktop DT, the switching unit 126 is further configured to determine whether the application corresponding to the desktop icon at the executed predetermined position requires the electronic device 100 to be unlocked. It should be noted that, when the application corresponding to the desktop icon at the executed predetermined position requires the electronic device 100 to be unlocked, the switching unit 126 forces the electronic device 100 to enter the normal operating mode from the locked mode and execute the application corresponding to the lock icon at the executed predetermined position. When the application corresponding to the desktop icon at the executed predetermined position does not require the electronic device 100 to be unlocked, the switching unit 126 forces the electronic device 100 to operate in the locked mode to execute the application corresponding to the desktop icon at the executed predetermined position. For example, as shown in FIG. 1, the switching unit 126 forces the electronic device 100 to enter the normal operating mode from the locked mode and execute the application corresponding to the lock icon O1 at the first predetermined position, when the predetermined gesture has been executed at the first predetermined position of the lock icon O1 on the lock layer S1. Furthermore, the switching unit 126 determines whether the application corresponding to the desktop icon DO1 at the second predetermined position requires the electronic device 100 to be unlocked, when the predetermined gesture has been executed at the second predetermined position of the desktop icon DO1 on the desktop DT. When the application corresponding to the desktop icon DO1 at the second predetermined position requires the electronic device 100 to be unlocked, the switching unit 126 forces the electronic device 100 to enter the normal operating mode from the locked mode and execute the application corresponding to the desktop icon DO1 at the second predetermined position. For example, because the desktop icon DO1 corresponds to website browsing, the electronic device 100 has to be unlocked to execute the application corresponding to the desktop icon DO1. In another embodiment, the switching unit 126 determines whether the application corresponding to the desktop icon DO2 at the second predetermined position requires the electronic device 100 to be unlocked, when the predetermined gesture has been executed at the second predetermined position of the desktop icon DO2 on the desktop DT. Furthermore, the switching unit 126 forces the electronic device 100 to execute the application corresponding to the desktop icon DO2 at the second predetermined position, when the application corresponding to the desktop icon DO2 at the second predetermined position does not require the electronic device 100 to be unlocked. For example, because the desktop icon DO2 corresponds to music playing, the electronic device 100 does not have to be unlocked to execute the application corresponding to the desktop icon DO2.

In another embodiment, when the predetermined gesture has been executed at the predetermined position corresponding to one of the event icons NO1-NON of the event layer N1, the switching unit 126 is further configured to determine whether the application corresponding to the event icon at the executed predetermined position requires the electronic device 100 to be unlocked. The switching unit 126 forces the electronic device 100 to enter the normal operating mode from the locked mode to execute the application corresponding to the event icon at the predetermined position, when the application corresponding to the event icon at the executed predetermined position requires the electronic device 100 to be unlocked. The switching unit 126 forces the electronic device 100 to execute the application corresponding to the event icon at the executed predetermined position in the locked mode, when the application corresponding to the event icon at the executed predetermined position does not require the electronic device 100 to be unlocked. For example, the switching unit 126 detects whether the application corresponding to the event icon NO1 at the third predetermined position requires the electronic device 100 to be unlocked, when the predetermined gesture has been executed at the third predetermined position of the event icon NO1 on the event layer N1. The switching unit 126 forces the electronic device 100 to enter the normal operating mode from the locked mode and execute the application corresponding to the event icon NO1 at the third predetermined position, when the application corresponding to the event icon NO1 at third predetermined position requires the electronic device 100 to be unlocked. For example, because the event icon NO1 corresponds to mail receiving/sending, the electronic device 100 has to be unlocked to execute the application corresponding to event icon NO1. In another embodiment, the switching unit 126 detects whether the application corresponding to the event icon NO2 at the third predetermined position requires the electronic device 100 to be unlocked, when the predetermined gesture has been executed at the third predetermined position corresponding to the event icon NO2 on the event layer N1. The switching unit 126 forces the electronic device 100 to execute the application corresponding to the event icon NO2 at the third predetermined position, when the application corresponding to the event icon NO2 at the predetermined position does not require the electronic device 100 to be unlocked. For example, because the desktop icon DO2 corresponds to call rejection, the electronic device 100 does not have to be unlocked to execute the application corresponding to the event icon NO2.

The detection unit 128 is configured to detect whether a new event has occurred when the electronic device 100 is in the locked mode. When the new event has occurred, the detection unit 128 forces the image processing unit 122 to insert the event layer N1 above the lock layer S1 or between the lock layer S1 and the desktop DT, as shown in FIGS. 3-4.

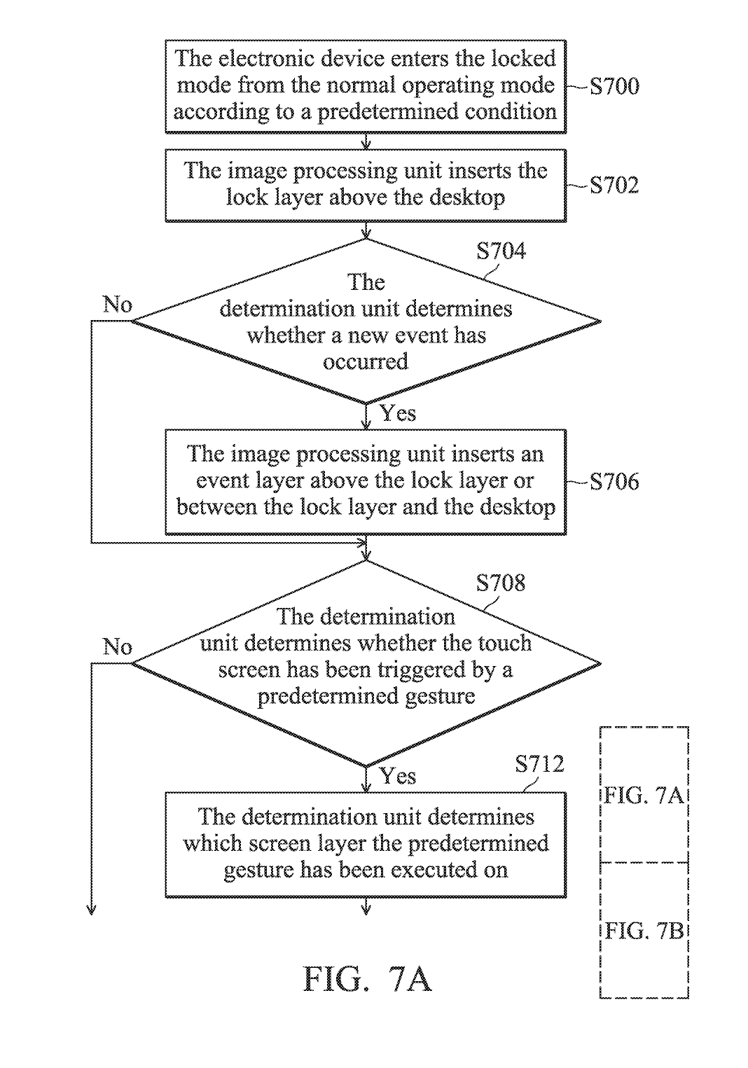

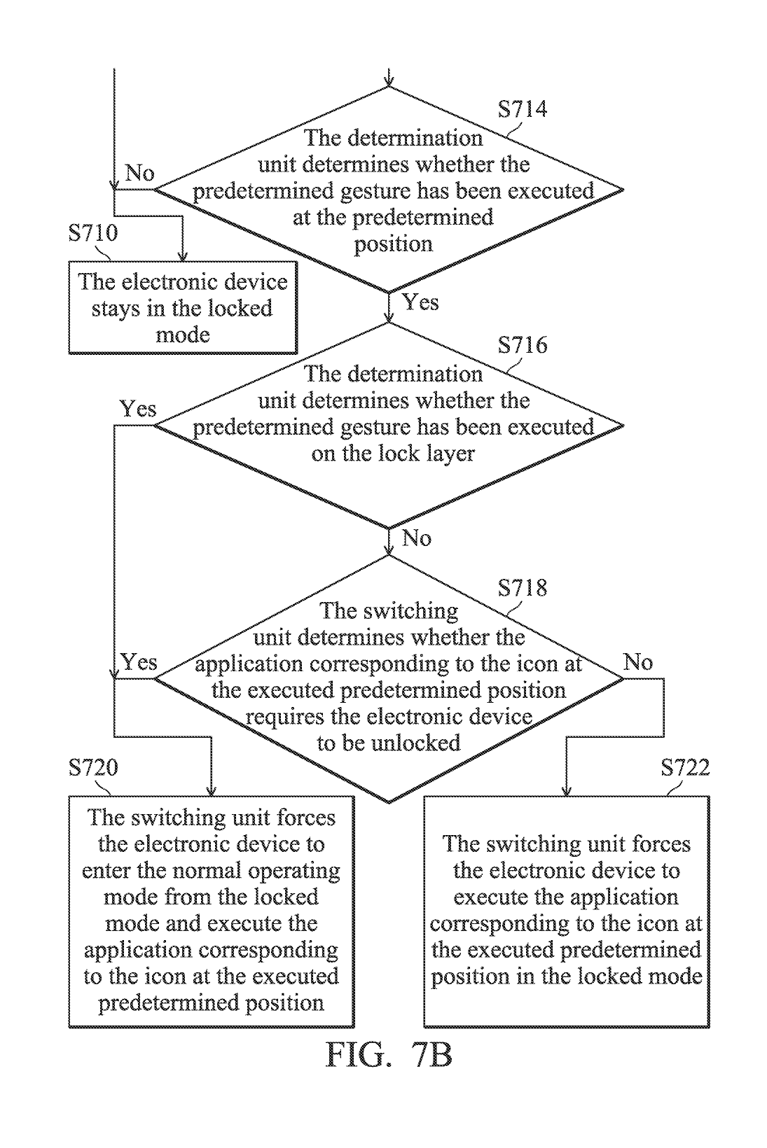

FIGS. 7A-7B show a flowchart of a method for locking the electronic device according to an embodiment of the present invention. The method is applied to an electronic device 100 with a touch screen 110, wherein the electronic device 100 is capable of operating in a normal operating mode or a locked mode, and the process starts at Step S700.

In the Step S700, the electronic device 100 enters the locked mode from the normal operating mode according to a predetermined condition. It should be noted that the electronic device 100 meets the predetermined condition when the electronic device 100 is not triggered at a predetermined time or receives a lock signal, but it is not limited thereto.

Next, in the Step S702, the image processing unit 122 inserts the lock layer S1 above the desktop DT which is corresponding to the normal operating mode, wherein the lock layer S1 includes a first transparent area V1 and/or a first non-transparent area V1′. The first non-transparent area V1′ includes at least one of the lock icons O1-ON, and the lock icons O1-ON are disposed at different predetermined positions (i.e. first predetermined positions) and corresponding to different applications, respectively. For the details of the lock layer S1, reference can be made to FIGS. 1-5, and it is not discussed in further detail herein.

Next, in the Step S704, the determination unit 124 determines whether a new event has occurred. For example, the new event can be an incoming call, a new massage, game notices, etc., and is not limited thereto. When the new event has occurred, Step S706 is performed; otherwise, Step S708 is performed.

Next, in the Step S706, the image processing unit 122 inserts an event layer N1 above the lock layer S1 or between the lock layer S1 and the desktop DT, as shown in FIGS. 3-4. Furthermore, the event layer N1 includes a second transparent area V2 and/or a second non-transparent area V2′, wherein the second non-transparent area V2′ includes at least one of the event icons NO1-NON. The event icons NO1-NON are disposed at different predetermined positions (i.e. the third predetermined positions) and corresponding to different applications, respectively. For the details of the event layer N1, reference can be made to FIGS. 1-5, and it is not discussed in further detail herein.

Next, in the Step S708, the determination unit 124 determines whether the touch screen 110 has been triggered by a predetermined gesture. For example, the predetermined gesture of the present invention can be ticking or circling action, but it is not limited thereto. Step S712 is performed when the determination unit 124 determines that the touch screen 110 has been triggered by the predetermined gesture, and Step S710 is performed when the determination unit 124 determines that the touch screen 110 is not triggered by the predetermined gesture.

Next, in the Step S710, the electronic device 100 stays in the locked mode. The process ends at Step S710.

Next, in the Step S712, the determination unit 124 determines which screen layer (i.e. the desktop DT, the lock layer S1, or the event layer N1) the predetermined gesture has been executed on according to the position of the predetermined gesture. In one of the embodiments, the determination unit 124 determines whether the predetermined gesture has been executed on the lock layer S1 according to the position of the predetermined gesture on the touch screen 110. For example, the determination unit 124 determines that the predetermined gesture has been executed on the lock layer S1, when the lock layer S1 does not have the first transparent area V1 (not shown) and the predetermined gesture has been executed on the touch screen 110.

In another embodiment, the determination unit 124 determines whether the predetermined gesture has been executed on the desktop DT or the lock layer S1 according to the first transparent area V1, first non-transparent area V1′ and the position of the predetermined gesture on touch screen 110, as shown in FIG. 1. For example, the determination unit 124 determines whether the touch screen 110 has been triggered by the predetermined gesture according to the signal produced by the touch screen 110. Furthermore, the determination unit 124 determines that the predetermined gesture has been executed on the desktop DT, when the predetermined gesture has been executed on the first transparent area V1 instead of the first non-transparent area V1′. The determination unit 124 determines that the predetermined gesture has been executed on the lock layer S1, when the predetermined gesture has been executed on the first non-transparent area V1′ instead of the first transparent area V1.

In another embodiment, as shown in FIGS. 3-4, the determination unit 124 determines whether the predetermined gesture has been executed on the desktop DT, the lock layer S1, or the event layer N1 according to the first transparent area V1, the first non-transparent area V1′, the second transparent area V2, the second non-transparent area V2′, and the position of the predetermined gesture on the touch screen 110.

For example, the determination unit 124 determines that the predetermined gesture has been executed on the event layer N1, when the predetermined gesture has been executed on the second non-transparent area V2′ instead of the second transparent area V2, as FIG. 3 shows. The determination unit 124 determines that the predetermined gesture has been executed on the lock layer S1, when the predetermined gesture has been executed on the second transparent area V2 and the first non-transparent area V1′. The determination unit 124 determines that the predetermined gesture has been executed on the desktop DT, when the predetermined gesture has been executed on the first transparent area V1 and the second transparent area V2. In the embodiment of FIG. 4, the determination unit 124 determines that the predetermined gesture has been executed on the lock layer S1 when the predetermined gesture has been executed on the first non-transparent area V1′ instead of the first transparent area V1. The determination unit 124 determines that the predetermined gesture has been executed on the event layer N1, when the predetermined gesture has been executed on the first transparent area V1 and the second non-transparent area V2′. The determination unit 124 determines that the predetermined gesture has been executed on the desktop DT, when the predetermined gesture has been executed on the first transparent area V1 and the second transparent area V2. It should be noted that the determination unit 124 can produce a determining signal corresponding to the executed screen layer according to the determination.

Next, in the Step S714, the determination unit 124 determines whether the predetermined gesture has been executed at the predetermined position on the executed screen layer. For example, the determination unit 124 determines whether the predetermined gesture has been executed at the predetermined position corresponding to one of the lock icons O1-ON, when the predetermined gesture has been executed on the lock layer S1. In another embodiment, the determination unit 124 determines whether the predetermined gesture has been executed at the predetermined position corresponding to one of the desktop icons DO1-DON, when the predetermined gesture has been executed on the desktop DT. In yet another embodiment, the determination unit 124 determines whether the predetermined gesture has been executed at the predetermined position corresponding to one of the event icons NO1-NON, when the predetermined gesture has been executed on the event layer N1. When the determination unit 124 determines that the predetermined gesture has been executed at the predetermined position of one of the screen layers, Step S716 is performed, otherwise, Step S710 is performed.

Next, in the Step S716, when the determination unit 124 determines that the predetermined gesture has been executed on the lock layer S1, Step S720 is performed, otherwise, Step S718 is performed.

In the Step S718, the switching unit 126 determines whether the application corresponding to the icon at the executed predetermined position requires the electronic device 100 to be unlocked. When the switching unit 126 determines the application corresponding to the icon at the executed predetermined position requires the electronic device 100 to be unlocked, Step S720 is performed, otherwise Step S722 is performed.

When the predetermined gesture has been executed at the predetermined position corresponding to one of the desktop icons DO1-DON on the desktop DT, the switching unit 126 determines whether the application corresponding to the desktop icon at the executed predetermined position requires the electronic device 100 to be unlocked. For example, the switching unit 126 determines whether the application corresponding to the desktop icon DO1 at the second predetermined position requires the electronic device 100 to be unlocked, when the predetermined gesture has been executed at the predetermined position corresponding to the desktop icon DO1 on the desktop DT. For instance, because the desktop icon DO1 corresponds to website browsing, the electronic device 100 has to be unlocked to execute the application corresponding to the desktop icon DO1. In another embodiment, the switching unit 126 determines whether the application corresponding to the desktop icon DO2 at the predetermined position requires the electronic device 100 to be unlocked, when the predetermined gesture has been executed at the second predetermined position corresponding to the desktop icon DO2. For example, because the desktop icon DO2 corresponds to music playing, the electronic device 100 does not have to be unlocked to execute the application corresponding to the desktop icon DO2.

In another embodiment, when the predetermined gesture has been executed at the predetermined position corresponding to one of the event icons NO1-NON of the event layer N1, the switching unit 126 determines whether the application corresponding to the event icon at the executed predetermined position requires the electronic device 100 to be unlocked. For example, when the predetermined gesture has been executed at the predetermined position corresponding to the event icon NO1 on the event layer N1, the switching unit 126 determines whether the application corresponding to the event icon NO1 at the executed predetermined position requires the electronic device 100 to be unlocked. For instance, because the event icon NO1 corresponds to mail receiving/sending, the electronic device 100 has to be unlocked to execute the application corresponding to event icon NO1. In another embodiment, the switching unit 126 detects whether the application corresponding to the event icon NO2 at the predetermined position requires the electronic device 100 to be unlocked, when the predetermined gesture has been executed at the predetermined position correspond to the event icon NO2 on the event layer N1. For example, because the desktop icon DO2 corresponds to call rejection, the electronic device 100 does not have to be unlocked to execute the application corresponding to the event icon NO2.

In the Step S720, the switching unit 126 forces the electronic device 100 to enter the normal operating mode from the locked mode and execute the application corresponding to the icon at the executed predetermined position. In one of the embodiments, when the predetermined gesture has been executed at the predetermined position corresponding to one of the lock icons O1-ON on the lock layer S1, the switching unit 126 forces the electronic device 100 to enter the normal operating mode from the locked mode and execute the application corresponding to the lock icon at the executed predetermined position. In another embodiment, when the predetermined gesture has been executed at the predetermined position corresponding to one of the desktop icons DO1-DON of the desktop DT, the switching unit 126 forces the electronic device 100 to enter the normal operating mode form the locked mode and execute the application corresponding to the desktop icon at the executed predetermined position. In yet another embodiment, when the predetermined gesture has been executed at the predetermined position corresponding to one of the event icons NO1-NON on the event layer N1, the switching unit 126 forces the electronic device 100 to enter the normal operating mode from the locked mode and execute the application corresponding to the event icon at the executed predetermined position. The process ends at Step S720.

In the Step S722, the switching unit 126 forces the electronic device 100 to execute the application corresponding to the icon at the executed predetermined position in the locked mode. In one of the embodiments, when the predetermined gesture has been executed at the predetermined position corresponding to one of the lock icons O1-ON on the lock layer S1, the switching unit 126 forces the electronic device 100 to execute the application corresponding to the lock icon at the executed predetermined position in the locked mode. In another embodiment, when the predetermined gesture has been executed at the predetermined position corresponding to one of the event icons NO1-NON on the event layer N1, the switching unit 126 forces the electronic device 100 to execute the application corresponding to the event icon at the executed predetermined position in the locked mode. The process ends at Step S722.

The methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device capable of operating in a normal operating mode and a locked mode, comprising:
a touch screen, configured to receive a predetermined gesture and display a plurality of screen layers, wherein the screen layers comprise a lock layer corresponding to the locked mode and a desktop corresponding to the normal operating mode;
an image processing unit, configured to insert the lock layer above the desktop when the electronic device is in the locked mode, wherein the lock layer comprises a first non-transparent area with a lock icon, and the lock icon is disposed at a first predetermined position on the lock layer;
a determination unit, configured to determine whether the predetermined gesture has been executed at the first predetermined position on the lock layer when the electronic device is in the lock mode and the touch screen has been triggered by the predetermined gesture; and
a switching unit, configured to force the electronic device to enter the normal operating mode from the lock mode and execute a first application corresponding to the lock icon at the first predetermined position, when the predetermined gesture has been executed at the first predetermined position on the lock layer.

2. The electronic device as claimed in claim 1, wherein the lock layer further comprises a first transparent area configured to display a desktop icon on the desktop, the desktop icon is disposed at a second predetermined position on the desktop, and the determination unit is further configured to determine whether the predetermined gesture has been executed on the desktop or the lock layer.

3. The electronic device as claimed in claim 2, wherein the determination unit determines that the predetermined gesture has been executed on the lock layer when the predetermined gesture has been executed on the first non-transparent area, and the determination unit determines that the predetermined gesture has been executed on the desktop when the predetermined gesture has been executed on the first transparent area.

4. The electronic device as claimed in claim 2, wherein the switching unit is further configured to determine whether a second application corresponding to the desktop icon at the second predetermined position requires the electronic device to be unlocked.

5. The electronic device as claimed in claim 4, wherein the switching unit forces the electronic device to enter the normal operating mode from the locked mode and execute the second application corresponding to the desktop icon at the second predetermined position, when the second application requires the electronic device to be unlocked.

6. The electronic device as claimed in claim 4, wherein the switching unit forces the electronic device to execute the second application corresponding to the desktop icon at the second predetermined position in the locked mode, when the second application does not require the electronic device to be unlocked.

7. The electronic device as claimed in claim 2, further comprising a detection unit configured to detect whether a new event has occurred when the electronic device is in the locked mode, wherein the image processing unit inserts an event layer having a second transparent area and a second non-transparent area above the lock layer or between the lock layer and the desktop when the new event has occurred, and the determination unit is further configured to determine whether the predetermined gesture has been executed on the desktop, the lock layer, or the event layer.

8. The electronic device as claimed in claim 7, wherein when the image processing unit inserts the event layer above the lock layer, the determination unit
determining that the predetermined gesture has been executed on the event layer when the predetermined gesture has been executed on the second non-transparent area;
determining that the predetermined gesture has been executed on the lock layer when the predetermined gesture has been executed on the second transparent area and the first non-transparent area; and
determining that the predetermined gesture has been executed on the desktop when the predetermined gesture has been executed on the second transparent area and the first transparent area.

9. The electronic device as claimed in claim 7, wherein when the image processing unit inserts the event layer between the lock layer and the desktop, the determination unit executes the steps of:
determining that the predetermined gesture has been executed on the lock layer when the predetermined gesture has been executed on the first non-transparent area;
determining that the predetermined gesture has been executed on the event layer when the predetermined gesture has been executed on the first transparent area and the second non-transparent area; and
determining that the predetermined gesture has been executed on the desktop when the predetermined gesture has been executed on the first transparent area and second transparent area.

10. The electronic device as claimed in claim 7, wherein the event layer further comprises an event icon disposed at a third predetermined position, and the switching unit is further configured to determine whether a third application corresponding to the event icon at the third predetermined position requires the electronic device to be unlocked.

11. The electronic device as claimed in claim 10, wherein the switching unit and execute the third application corresponding to the event icon at the third predetermined position when the third application requires the electronic device to be unlocked.

12. A method for unlocking an electronic device capable of operating in a normal operating mode and a locked mode, wherein the electronic device comprises a touch screen, the method comprising:
inserting a lock layer above a desktop corresponding to the normal operating mode when the electronic device is in the locked mode, wherein the lock layer comprises a first non-transparent area, and the first non-transparent area comprises a lock icon disposed at a first predetermined position;
determining whether the touch screen has been triggered by a predetermined gesture when the electronic device is in the locked mode;
determining whether the predetermined gesture has been executed on the lock layer when the touch screen has been triggered by the predetermined gesture;
determining whether the predetermined gesture has been executed at the first predetermined position when the predetermined gesture has been executed on the lock layer; and
forcing the electronic device to enter the normal operating mode from the locked mode and execute a first application corresponding to the lock icon at the first predetermined position when the predetermined gesture has been executed at the first predetermined position.

13. The method as claimed in claim 12, wherein the lock layer further comprises a first transparent area configured to display a desktop icon on the desktop, and the desktop icon is disposed at a second predetermined position, the method
determining whether the predetermined gesture has been executed on the desktop or the lock layer when the touch screen has been triggered by the predetermined gesture; and
determining whether the predetermined gesture has been executed at the second predetermined position when the predetermined gesture has been executed on the desktop.

14. The method as claimed in claim 13, further comprising:
determining whether a second application corresponding to the desktop icon at the second predetermined position requires the electronic device to be unlocked, when the predetermined gesture has been executed at the second predetermined position on the desktop; and
forcing the electronic device to enter the normal operating mode from the locked mode and execute the second application corresponding to the desktop icon at the second predetermined position, when the second application requires the electronic device to be unlocked.

15. The method as claimed in claim 13, further comprising:
detecting whether a new event has occurred;
inserting an event layer having a second transparent area and a second non-transparent area above the lock layer or between the lock layer and the desktop when the new event has occurred, wherein the event layer comprising an event icon, and the event icon is disposed at a third predetermined position;
determining whether the predetermined gesture has been executed on the desktop, the lock layer, or the event layer;
determining whether the predetermined gesture has been executed at the third predetermined position when the predetermined gesture has been
determining whether a third application corresponding to the event icon at the third predetermined position requires the electronic device to be unlooked, when the third predetermined gesture has been executed at the third predetermined position; and
forcing the electronic device to enter the normal operating mode from the locked mode and execute the third application corresponding to the event icon at the third predetermined position, when the third application requires the electronic device to be unlooked.
